(19) United States
(12) Patent Application Publication
(10) Pub. No.: US 2017/0042370 A1
(43) Pub. Date: Feb. 16, 2017

(54) Automatic Constant Temperature Cookware Utensil and Combined Structure with Eletro-magnetic Heating Device

(71) Applicant: TIANYU IMPORT & EXPORT TRADING LTD., Zhaoqing City (CN)

(72) Inventor: Zhe LIAO, Zhaoqing City (CN)

(21) Appl. No.: 15/235,636

(22) Filed: Aug. 12, 2016

(30) Foreign Application Priority Data
Aug. 14, 2015 (CN) 201520612565.5
Nov. 3, 2015 (CN) 201520866671.6
Dec. 8, 2015 (CN) 201521008594.7

(51) Int. Cl. A47J 36/02; H05B 6/12; A47J 27/00

(52) U.S. Cl. CPC A47J 36/02; A47J 27/002; A47J 27/004; H05B 6/1209; H05B 2206/023

(57) ABSTRACT

The present invention provides an automatic constant temperature cookware utensil, which includes a utensil body and a utensil bottom. A constant temperature layer is provided on an outer surface of the utensil body and/or the utensil bottom. Compared with the prior art, an automatic constant temperature cookware utensil of this invention has a bottom with constant temperature, which has good safety performance, protects food nutrition from destroying, effectively restrains oil and smoke, and decreases PM2.5.

### TECHNICAL FIELD

The present invention relates to a cookware utensil, and more particularly relates to an induction cooker heating automatic constant temperature cookware utensil.

### BACKGROUND

Nowadays cookware utensil used for induction cooker may have constantly rising temperature only if induction cooker is heating constantly, which is apt to lose food nutrition and coking, and cannot exhaust oil and smoke, even reaching fire point, resulting in safety incident. If a non-stick pan is heated constantly, a coating layer may be destroyed, because the coating layer cannot undergo heating temperature of up to 260 degree.

### SUMMARY OF THE PRESENT INVENTION

The main purpose of the present invention is to provide an automatic constant temperature cookware utensil which has a bottom with constant temperature, which has good safety performance, protects food nutrition from destroying, effectively restrains oil and smoke, and decreases PM2.5.

In order to achieve the above purpose, the present invention provides a technical solution as below.

An automatic constant temperature cookware utensil, comprises a utensil body and a utensil bottom. A constant temperature layer is provided on an outer surface, on an inner surface or between the inner surface and the outer surface of the utensil body and the utensil bottom.

The constant temperature layer is made of precise alloy material, preferably thermal resistor material of precise alloy material. The precise alloy material and the thermal resistor material both have PTC effect, namely positive temperature coefficient effect. The precise alloy material has a special curie point (or curie temperature). When the precise alloy material is heated on an induction cooker, and temperature rises to beyond curie temperature, the material will lose magnetism, and limit electro-magnetic effect heating, decreasing temperature; when temperature sets down to below curie temperature, magnetism is restored, and temperature rises by electro-magnetic effect, again and again, thereby achieving constant temperature. This invention is application of the principle.

The precise alloy material has preferably a curie temperature between 30 degree centigrade and 260 degree centigrade, and further preferably a curie temperature between 180 degree centigrade and 230 degree centigrade, and is, for example, precise alloy 4J36 (produced by Shanghai Kaiye Metal Manufacture Inc.) or precise alloy 4J32 (produced by Shanghai Kaiye Metal Manufacture Inc.). The precise alloy 4J36 is a special low expansion ferronickel with a super low expansion coefficient and a curie temperature of 230 degree centigrade; the precise alloy 4J32 is also called super-invar alloy with a curie temperature of 220 degree centigrade.

Besides, the precise alloy material preferably further includes following alloy materials:

| alloy type | alloy designation | Curie point |
|---|---|---|
| Ferro-manganese | 4J59 | 70 |
| constant elastic alloy | 3J53 | 110 |
| constant elastic alloy | 3J53Y | 110 |
| elastic alloy | Ni₄₄MoTiAl | 120 |
| constant elastic alloy | 3J58 | 130 |
| elastic alloy | 3J54 | 130 |
| elastic alloy | 3J58 | 130 |
| elastic alloy | 3J59 | 150 |
| amorphous soft | (FeNiCo)₇₈(SiB)₂₂ | 150 |
| magnetism alloy | | |
| elastic alloy | 3J53 | 155 |
| elastic alloy | 3J61 | 160 |
| elastic alloy | 3J62 | 165 |
| precise alloy | 4J36 | 230 |
| precise alloy | 4J32 | 220 |

The alloy material above may be made by Shanghai Kaiye Metal Manufacture Inc. or obtained through other public sales channels.

The utensil bottom and/or utensil body is formed by at least a metal layer, for example a single layer of iron or aluminum. The constant temperature layer may be formed on outside of the metal layer, namely an outer surface, or formed on inside of the metal layer, namely an inner surface.

Preferably, the utensil body and/or the utensil bottom is forming by three metal layers. A first layer from inside to outside is aluminum layer, a second layer is iron layer or steel layer, and a third layer is aluminum layer. The constant temperature layer is formed on outside of the metal layers, namely outside of the third layer. The utensil bottom and/or the utensil body is formed by multiple layers, so that the deformation of the utensil bottom or the utensil body is decreased, and a service life of the cookware utensil is extended. Particularly regarding to the utensil bottom, according to industrial standard, the utensil bottom is not provided horizontally, but needs to be concaved inwards to a certain degree, such as curved upward along a medial axle shown in FIG. 1, so as to prevent unstable placement of the cookware utensil caused by the deformation of the utensil bottom. Multiple layers structure of the cookware utensil may effectively decrease the deformation of the cookware utensil during heating and cooling process. The more the layers are, the deformation is smaller. In addition, the aluminum layer and the steel layer both have a good effect of heat conduction, and transfer heat uniformly, and the local temperature being too high or too low caused by non-uniform heat conduction can be avoided.

Preferably, the utensil bottom and/or the utensil body is formed by four metal layers. A first layer from inside to outside is steel layer, a second layer is aluminum layer, a third layer is steel layer or iron layer, and a fourth layer is aluminum layer. The constant temperature layer is formed on an outer surface of the fourth layer or an inner surface of the first layer.

Preferably, the utensil bottom and/or the utensil body is formed by five metal layers. A first layer from inside to outside is aluminum layer, a second layer is iron layer or steel layer, a third layer is aluminum layer, a fourth layer is iron layer or steel layer, and a fifth layer is aluminum layer. The constant temperature layer is formed on an outer surface of the fifth layer, or between the second layer and the third layer, or between the third layer and the fourth layer.

Preferably, the utensil bottom and/or the utensil body is formed by six metal layers. A first layer is steel layer, a second layer is aluminum layer, a third layer is steel layer or iron layer, a fourth layer is aluminum layer, a fifth layer is iron layer or steel layer, and a sixth layer is aluminum layer. The constant temperature layer is formed on an outer surface of the sixth layer.

Besides, the constant temperature layer may be formed by two layers or multiple layers respectively attached on the utensil bottom and/or the utensil body.

The utensil bottom and/or the utensil body may be fonned by multiple layers for more balanced temperature of the utensil bottom and/or the utensil body.

Preferably, the aluminum layer has a thickness of 0.1 to 8 mm, the steel layer has a thickness of 0.1 to 1.5 mm, and the constant temperature layer has a thickness of 0.1 to 3 mm.

The constant temperature layer defines at least a through hole.

Preferably, the through hole is a circular through hole, long strip through hole, arc-shaped through hole, rectangular hole or triangular hole, or combination of above holes.

Further, the through holes form a through holes array, which is evenly distributed the constant temperature layer. Preferably, the constant temperature layer is formed on the utensil bottom, and the through holes on the constant temperature layer are distributed centrically. The through holes are distributed for more balanced temperature of the utensil bottom.

Preferably, total area of the through holes is 5%-50% of total area of the constant temperature layer, more preferably 10%-20%. This design saves manufacture cost of the constant temperature layer, and meets maximum function of the constant temperature layer.

Compared with the prior art, the invention has benefits: the automatic constant temperature cookware utensil will not suffer high temperature and destroy lifespan of the coating layer, and protects the non-stick and food safety; when cooking, the food nutrition will not be destroyed, and indeed nutrition cooking and healthy life (at most healthy cook temperature, not beyond 230 degree); when an induction cooker is heating, the constant temperature cookware utensil is controlled to be any temperature between 30-230 degrees for saving energy. At the same time, constant temperature and low temperature cooking, effectively decreases oil and smoke, and reduces that food is excessively heated to produce hazardous substance, fully preventing from safety risk of forgetting turning off the induction cooker.

Additionally, the invention defines a plurality of through holes on the constant temperature layer. At one side, contact area of the constant temperature layer and the induction cooker is reduced, decreasing magnetic induction effect of the constant temperature layer, and temperature of the utensil bottom is controlled to be reasonable temperature interval; at other side, the constant temperature layer defines through holes, decreasing material consuming of constant temperature layer thereby decreasing manufacture cost.

This invention further provides a combined structure of automatic constant temperature cookware utensil and electro-magnetic heating device, which includes above automatic constant temperature cookware utensil and electro-magnetic heating device. The electro-magnetic heating device comprises an electro-magnetic heating device body and a heating plate provided on the electro-magnetic heating device body. The automatic constant temperature cookware utensil is provided on the electro-magnetic heating device. The distance between bottom of the automatic constant temperature cookware utensil, namely an outer side of the utensil bottom, and the heating plate of the electro-magnetic heating device is 0˜10 cm, preferably 0.1˜3 cm. That is, the automatic constant temperature cookware utensil of this invention may be heated by a way of directly contacting the electro-magnetic heating device, but also not directly contacting the electro-magnetic heating device. This is because, the electro-magnetic heating device will generate magnetic field during working process, and electromagnetic induction is generated in the constant temperature layer material of the bottom of the automatic constant temperature cookware utensil under the action of the magnetic field, to generate eddy current and start to emit heat. When the temperature rises to beyond the curie temperature of the constant temperature layer material, the constant temperature layer material will lose magnetism, and electro-magnetic effect heating is limited, so as to decrease temperature; when the temperature sets down to below curie temperature of the material, magnetism can be restored again, and the temperature rises by electro-magnetic effect, again and again, thereby achieving constant temperature. Additionally, this invention further changes conception that prior art cookware utensil must contact the electro-magnetic heating device to heat.

### BRIEF DESCRIPTION OF THE DRAWINGS

FIG. 1 is a schematically structural view of an embodiment 1 of the invention.

FIG. 2 is a schematically structural view of an embodiment 2 of the invention.

FIG. 3 is a schematically structural view of an embodiment 3 of the invention.

FIG. 4 is a schematically structural view of an embodiment 6 of the invention.

FIG. 5 is an enlarged view of part I of FIG. 4.

FIG. 6 is a schematically structural view of an embodiment 7 of the invention.

FIG. 7 is an enlarged view of part II of FIG. 6.

FIG. 8 is a schematically structural view of a constant temperature layer of an embodiment 9 of the invention.

FIG. 9 is a schematically structural view of a constant temperature layer with long strip through holes of the invention.

FIG. 10 is a schematically structural view of a constant temperature layer with long strip through holes and arc-shaped through holes of the invention.

### DETAILED DESCRIPTION OF THE PREFERRED EMBODIMENT

The present invention will be further described combined with detailed embodiments.

### Embodiment 1

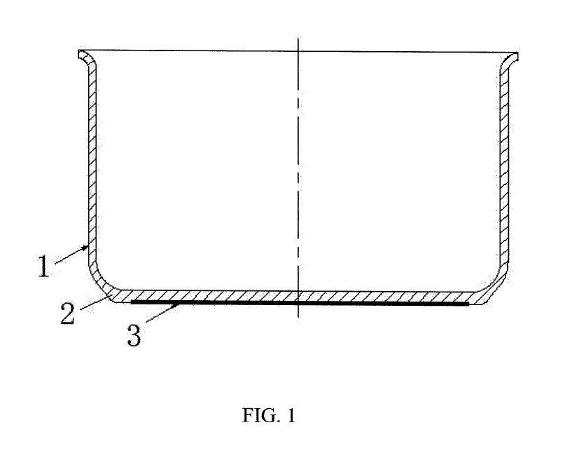

As shown in FIG. 1, this invention involves an automatic constant temperature cookware utensil for induction cooker heating, and includes a utensil body 1 and a utensil bottom 2. The utensil body 1 and the utensil bottom 2 are both manufactured by aluminum. The utensil body 1 and the utensil bottom 2 are integrally formed by casting, and a constant temperature layer 3 is formed on an outer surface of the utensil bottom 2. The constant temperature layer 3 is made of precise alloy material. In this embodiment, the precise alloy material is preferably precise alloy 4J36 (produced by Shanghai Kaiye Metal Manufacture Inc.) or precise alloy 4J32 (produced by Shanghai Kaiye Metal Manufacture Inc.). The constant temperature layer 3 preferably has a thickness of 0.1 to 3 mm, in this embodiment 1.5 mm, and the constant temperature layer 3 is attached to the utensil bottom 2 by braze weld or friction pressure punch priming and so on.

Sure, the constant temperature layer 3 in this embodiment may be formed on an inner surface of the utensil bottom 2.

Besides, the precise alloy material is preferably following alloy materials:

| alloy type | alloy designation | Curie point |
|---|---|---|
| Ferro-manganese | 4J59 | 70 |
| alloy | | |
| constant elastic alloy | 3J53 | 110 |
| constant elastic alloy | 3J53Y | 110 |
| elastic alloy | Ni₄₄MoTiAl | 120 |
| constant elastic alloy | 3J58 | 130 |
| elastic alloy | 3J54 | 130 |
| elastic alloy | 3J58 | 130 |
| elastic alloy | 3J59 | 150 |
| amorphous soft | (FeNiCo)₇₈(SiB)₂₂ | 150 |
| magnetism alloy | | |
| elastic alloy | 3J53 | 155 |
| elastic alloy | 3J61 | 160 |
| elastic alloy | 3J62 | 165 |
| precise alloy | 4J36 | 230 |
| precise alloy | 4J32 | 220 |

### Embodiment 2

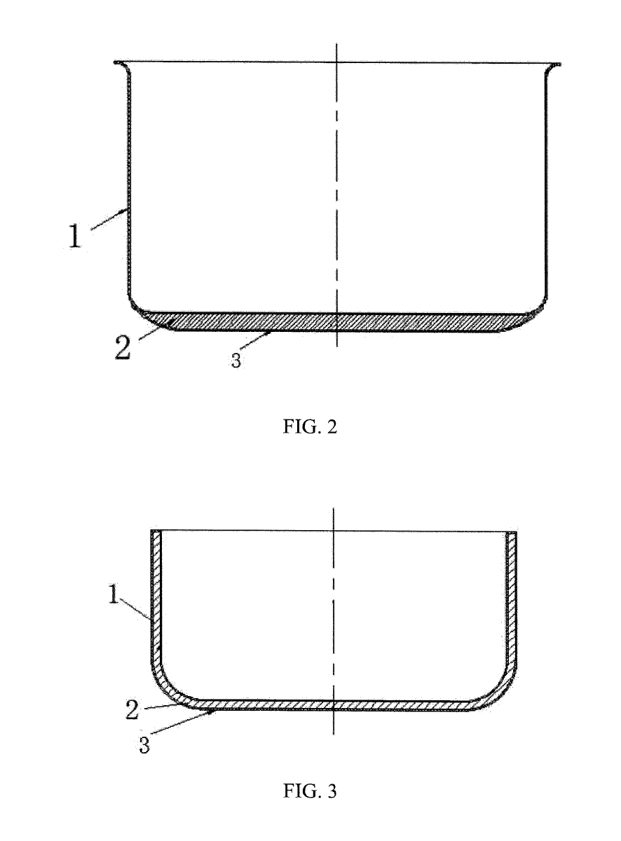

This embodiment improves on the basis of the embodiment 1. As shown in FIG. 2, in this embodiment, the utensil body 1 is made of steel, and the utensil bottom 2 is made of aluminum. A constant temperature layer 3 is coated on an outer surface of the utensil bottom 2. The constant temperature layer 3 is made of precise alloy material. The precise alloy material is preferably precise alloy 4J36 or precise alloy 4J32. The constant temperature layer 3 preferably has a thickness of 1 mm, and the constant temperature layer 3 is attached to the utensil bottom 2 by braze weld or friction pressure punch priming and so on.

Sure, the constant temperature layer 3 in this embodiment may be formed on an inner surface of the utensil body 1 and the utensil bottom 2.

### Embodiment 3

This embodiment improves on the basis of the embodiment 1. As shown in FIG. 3, the utensil body 1 and the utensil bottom 2 are made of steel aluminum alloy. A constant temperature layer 3 is formed on an outer surface of the utensil bottom 2. Other technical features are the same as those of embodiment 1.

### Embodiment 4

In this embodiment, the utensil bottom 2 and the utensil body 1 are both formed by three metal layers, namely a first layer, a second layer and a third layer from inside to outside. The first layer is aluminum layer, a second layer is iron layer or steel layer, and a third layer is aluminum layer. The constant temperature layer is formed on an outer surface of the third layer. The constant temperature layer may be attached on an outer surface of the utensil bottom 2, or be attached on an outer surface of the utensil body 1 and the utensil bottom 2. The first layer and the third layer are aluminum layer with a thickness of 0.1 to 8 mm preferably. The second layer iron layer or steel layer preferably has a thickness of 0.1 to 1.5 mm. The constant temperature layer 3 preferably has a thickness of 0.1 to 3 mm. The steel layer and the constant temperature layer 3 are attached to the utensil bottom 2 by braze weld or friction pressure punch priming and so on.

Sure, the utensil body 1 may be the same as the utensil bottom 2, which has three layers structure, and the constant temperature layer 3 is formed on outside of the utensil body 1 or the utensil bottom 2. Besides, the constant temperature layer 3 may be provided on inside of the utensil body 1 or utensil bottom 2, or between the first layer and the second layer metal layer, or between the second layer and the third layer metal layer.

### Embodiment 5

This embodiment improves on the basis of the embodiment 4. The utensil body 1 and the utensil bottom 2 are both formed by three metal layers, namely from inside to outside the first layer, the second layer and the third layer. The three metal layers are all steel layers, and other technical features are the same as those of embodiment 4.

### Embodiment 6

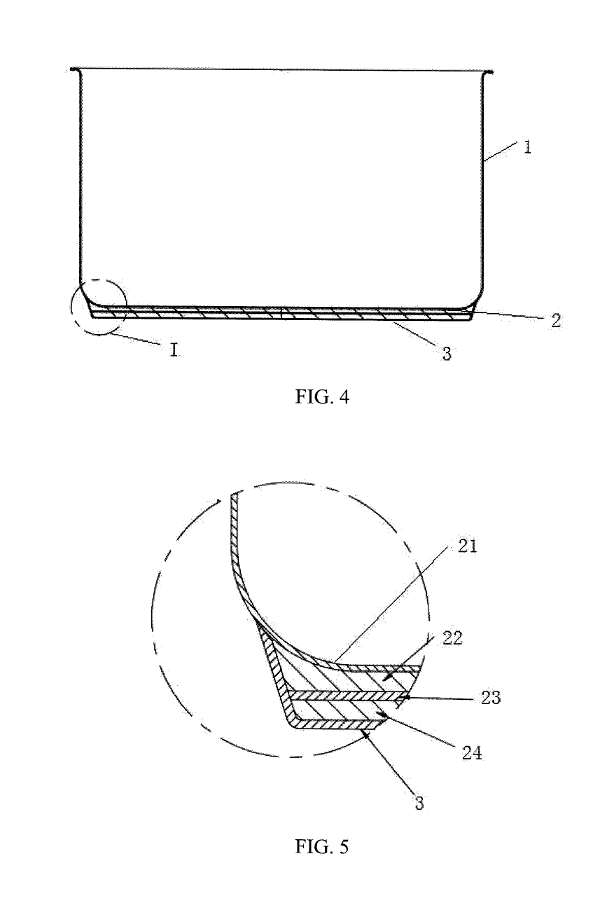

This embodiment improves on the basis of the embodiment 4. As shown in FIGS. 4 and 5, in this embodiment, the utensil bottom 2 is formed by four metal layers, namely from inside to outside the first layer 21, the second layer 22, the third layer 23 and the fourth layer 24. The first layer 21 is steel layer, the second layer 22 is aluminum layer, the third layer 23 is steel layer or iron layer, and the fourth layer 24 is aluminum layer. The constant temperature layer is attached to an outer surface of the fourth layer 24 or an inner surface of the first layer.

### Embodiment 7

This embodiment improves on the basis of the embodiment 4. In this embodiment, the utensil bottom 2 is formed by five metal layers, namely from inside to outside a first layer, a second layer, a third layer, a fourth layer and a fifth layer. The first layer is aluminum layer, the second layer is iron or steel layer, the third layer is aluminum layer, the fourth layer is iron or steel layer, and the fifth layer is aluminum layer. The constant temperature layer is attached to an outer surface of the fifth layer, or between the second layer and the third layer, or between the third layer and the fourth layer.

### Embodiment 8

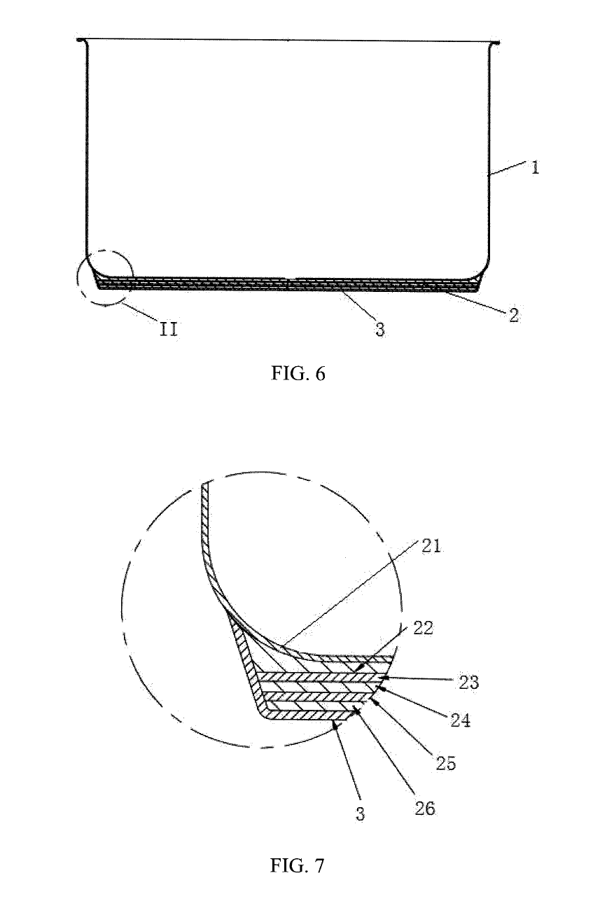

This embodiment improves on the basis of the embodiment 4. As shown in FIGS. 6 and 7, in this embodiment, the utensil bottom 2 is forming by six metal layers, namely from inside to outside the first layer 21, the second layer 22, the third layer 23, the fourth layer 24, the fifth layer 25 and the sixth layer 26. The first layer 21 is steel layer, the second layer 22 is aluminum layer, the third layer 23 is steel layer or iron layer, the fourth layer 24 is aluminum layer, the fifth layer 25 is iron layer or steel layer, and the sixth layer 26 is aluminum layer. The constant temperature layer is attached to an outer surface of the sixth layer 26.

### Embodiment 9

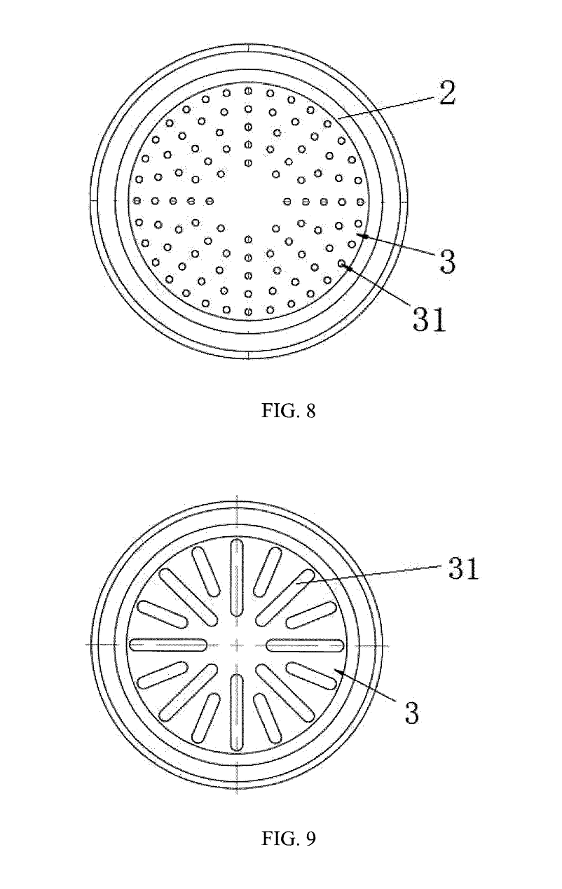

This embodiment improves on the basis of the embodiment 1. As shown in FIG. 8, an automatic constant temperature cookware utensil includes a utensil body 1 and a utensil bottom 2. The utensil body 1 and the utensil bottom 2 are both manufactured by aluminum. The utensil body 1 and the utensil bottom 2 are integrally formed by casting, and a constant temperature layer 3 is formed on an outer surface of the utensil bottom 2. The constant temperature layer 3 is made of precise alloy material. In this embodiment, the precise alloy material is preferably precise alloy 4J36 (produced by Shanghai Kaiye Metal Manufacture Inc.) or precise alloy 4J32 (produced by Shanghai Kaiye Metal Manufacture Inc.). The precise alloy material may be preferably 4J type or 1J type soft magnetism metal material, such as precise alloy 1J117, precise alloy 1J36.

The constant temperature layer 3 preferably has a thickness of 1.5 mm. The constant temperature layer 3 is circular, and has size which depends on bottom size of the cookware utensil. Generally, the constant temperature layer 3 preferably has a diameter between 10 cm to 25 cm. Sure, the constant temperature layer 3 has an area increased or decreased according to actual size of the utensil bottom 2. The constant temperature layer 3 defines a plurality of through holes 31. The through holes 31 are circular through holes. The through holes 31 decrease contact area of the contact temperature layer 3 and the induction cooker, and reduces magnetic induction effect of the contact temperature layer 3, whereby temperature of the utensil bottom is controlled to a reasonable scope; on the other hand, through holes of the contact temperature layer 3 may save material of contact temperature layer 3, reducing manufacture cost. Quantity and size of the through holes may be chosen according to actual need. A plurality of the through holes 31 form a through holes array. In order to make temperature of the utensil bottom even, all the through holes are distributed evenly on the contact temperature layer 3. Preferably, the through holes 31 of the contact temperature layer 3 may distributed centrically.

In this invention, hole diameter of the through holes 31 is not strictly restrained, ordinarily 0.2 mm-10 mm, preferably 0.2 mm-0.6 mm. The total area of the through holes 31 is 5%-50% of total area of the contact temperature layer 3, preferably 10%-20%.

The through holes 31 of the contact temperature layer 3 are processed by punching. The contact temperature layer 3 is processed by compound material process, braze weld or friction pressure priming, punch priming to be attached to the utensil bottom 2. When the compound material process, friction pressure priming, punch priming are used, metal material of the utensil bottom 2 may extend or fill the through holes 31.

As shown in FIG. 9, the through holes 31 of the contact temperature layer 3 may be long strip through holes. The long strip through holes 31 distributed on the contact temperature layer 3 radially and centrically. Besides, other pattern may be used, for example rectangular shape, triangular shape or flower shape and so on.

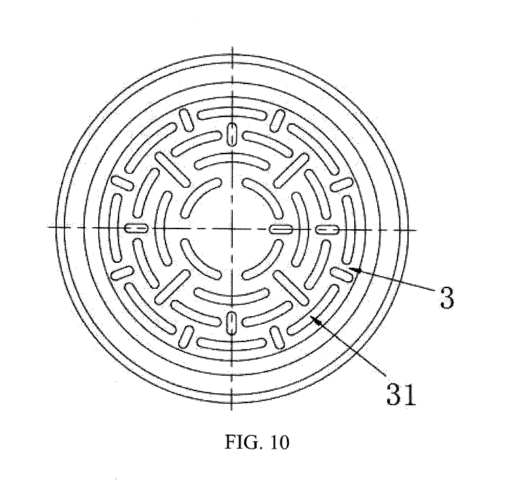

As shown in FIG. 10, through holes 31 of the contact temperature layer 3 may be combination of long strip through holes and arc-shaped through holes. The through holes 31 distributed on the contact temperature layer 3 centrically.

### Embodiment 10

This invention further provides a combination structure of automatic constant temperature cookware utensil and electro-magnetic heating device, and includes the above automatic constant temperature cookware utensil and electro-magnetic heating device. The electro-magnetic heating device comprises an electro-magnetic heating device body and a heating plate provided on the electro-magnetic heating device body. The automatic constant temperature cookware utensil is provided on the electro-magnetic heating device. Namely the distance between bottom of the automatic constant temperature cookware utensil and the heating plate of the electro-magnetic heating device is 0˜10 cm, preferably 0.1˜3 cm, namely the cookware utensil may not directly contact the electro-magnetic heating device. A lifting device, such as a support base, is provided on the electro-magnetic heating device to detach the bottom of the cookware utensil from the electro-magnetic heating device. The electro-magnetic heating device may be induction cooker or other device with electro-magnetic heating function.

In the embodiment, the cookware utensil is used on the induction cooker. When the induction cooker is heating, temperature of the utensil bottom rises. When measured temperature of the utensil bottom rises to 260 degree, temperature of the utensil bottom does not rise due to precise alloy 4J36 or precise alloy 4J32. The temperature of the utensil bottom automatically returns and remains 30 to 260 degree, preferably 30 to 230 degree. If the utensil bottom forms a non-stick layer, because the non-stick layer cannot endure heating temperature over 260 degree, the non-stick layer will not destroy lifespan of the coating layer due to high temperature, protecting non-stick performance and food safety. Because nutrition cooking does not ordinarily exceed 260 degree, food nutrition will not be destroyed when cooking, realizing nutrition cooking and healthy life indeed. Furthermore, when the induction cooker is heating, in this invention, temperature will automatically be controlled in preferable scope of 30 to 230 degree, saving energy, constant and low temperature cooking, effectively decreasing oil and smoke. At the same time, safety risk of forgetting turning off the induction cooker after cooking will be avoided fully.

While the above description constitutes a plurality of embodiments of the invention, which does not limit this invention, it will be appreciated for those skilled in the art that the present invention is susceptible to further equivalent modification and obvious change without departing from the fair meaning of the accompanying claims.

1. An automatic constant temperature cookware utensil, comprising a utensil body and a utensil bottom, characterized in that a constant temperature layer is provided on an outer surface, on an inner surface, or between the inner surface and the outer surface of the utensil body or the utensil bottom.

2. The automatic constant temperature cookware utensil according to claim 1, wherein the constant temperature layer is made of precise alloy material.

3. The automatic constant temperature cookware utensil according to claim 2, wherein the precise alloy material has a curie temperature between 30 degree centigrade and 260 degree centigrade.

4. The automatic constant temperature cookware utensil according to claim 3, wherein the precise alloy material has a curie temperature between between 180 degree centigrade and 230 degree centigrade.

5. The automatic constant temperature cookware utensil according to claim 3, wherein the precise alloy material is precise alloy 4J36, precise alloy 4J32, Ferro-manganese alloy 4J59, constant elastic alloy 3J53, constant elastic alloy 3J53Y, constant elastic alloy 3J58, elastic alloy 3J54, elastic alloy 3J58, elastic alloy 3J59, elastic alloy 3J53, elastic alloy 3J61, elastic alloy 3J62, elastic alloy Ni₄₄MoTiAl, precise alloy 4J36, precise alloy 4J32 or amorphous soft magnetism alloy (FeNiCo)₇₈(SiB)₂₂.

6. The automatic constant temperature cookware utensil according to claim 5, wherein the utensil bottom and/or utensil body is formed by at least a metal layer.

7. The automatic constant temperature cookware utensil according to claim 6, wherein the utensil body and/or the utensil bottom is formed by three metal layers, from inside to outside a first layer being aluminum layer, a second layer being iron layer or steel layer, and a third layer being aluminum layer, the constant temperature layer being formed on outside of the third layer.

8. The automatic constant temperature cookware utensil according to claim 6, wherein the utensil bottom and/or the utensil body is formed by four metal layers, from inside to outside a first layer being steel layer, a second layer being aluminum layer, a third layer being steel layer or iron layer, and a fourth layer being aluminum layer, the constant temperature layer being formed on an outer surface of the fourth layer or an inner surface of the first layer.

9. The automatic constant temperature cookware utensil according to claim 6, wherein the utensil bottom and/or the utensil body is formed by five metal layers, from inside to outside a first layer being aluminum layer, a second layer being iron layer or steel layer, a third layer being aluminum layer, a fourth layer being iron layer or steel layer, and a fifth layer being aluminum layer, the constant temperature layer being formed on an outer surface of the fifth layer, or between the second layer and the third layer, or between the third layer and the fourth layer.

10. The automatic constant temperature cookware utensil according to claim 6, wherein the utensil bottom and/or the utensil body is formed by six metal layers, from inside to outside a first layer being steel layer, a second layer being aluminum layer, a third layer being steel layer or iron layer, a fourth layer being aluminum layer, a fifth layer being iron layer or steel layer, and a sixth layer being aluminum layer, the constant temperature layer being formed on an outer surface of the sixth layer.

11. The automatic constant temperature cookware utensil according to claim 7, wherein the aluminum layer has a thickness of 0.1 to 8 mm, the steel layer has a thickness of 0.1 to 1.5 mm, and the constant temperature layer has a thickness of 0.1 to 3 mm.

12. The automatic constant temperature cookware utensil according to claim 1, wherein the constant temperature layer defines at least a through hole.

13. The automatic constant temperature cookware utensil according to claim 12, wherein the through hole is a circular through hole, long strip through hole, arc-shaped through hole, rectangular hole or triangular hole, or combination of above holes.

14. The automatic constant temperature cookware utensil according to claim 13, wherein the through holes form a through holes array, which are evenly distributed on the constant temperature layer, and the constant temperature layer is formed on the utensil bottom, the through holes on the constant temperature layer being distributed centrically.

15. The automatic constant temperature cookware utensil according to claim 13, wherein total area of the through holes is 5%-50% of total area of the constant temperature layer.

16. A combined structure of automatic constant temperature cookware utensil and electro-magnetic heating device, characterized in that it comprises the automatic constant temperature cookware utensil claimed in claim 1 and electro-magnetic heating device, the automatic constant temperature cookware utensil being provided on the electro-magnetic heating device, the distance between bottom of automatic constant temperature cookware utensil and the electro-magnetic heating device being 0˜10 cm.

17. The combined structure of automatic constant temperature cookware utensil and electro-magnetic heating device according to claim 16, wherein the distance between bottom of automatic constant temperature cookware utensil and the electro-magnetic heating device is 0.1˜3 cm.

18. The automatic constant temperature cookware utensil according to any one of claim 8, wherein the aluminum layer has a thickness of 0.1 to 8 mm, the steel layer has a thickness of 0.1 to 1.5 mm, and the constant temperature layer has a thickness of 0.1 to 3 mm.

19. The automatic constant temperature cookware utensil according to any one of claim 9, wherein the aluminum layer has a thickness of 0.1 to 8 mm, the steel layer has a thickness of 0.1 to 1.5 mm, and the constant temperature layer has a thickness of 0.1 to 3 mm.

20. The automatic constant temperature cookware utensil according to any one of claim 10, wherein the aluminum layer has a thickness of 0.1 to 8 mm, the steel layer has a thickness of 0.1 to 1.5 mm, and the constant temperature layer has a thickness of 0.1 to 3 mm.
